(19) United States
(12) Patent Application Publication
(10) Pub. No.: US 2026/0025410 A1
(43) Pub. Date: Jan. 22, 2026

(54) MACHINE LEARNING PIPELINE FOR DETECTING ZERO-DAY PHISHING KIT SOURCE CODES

(71) Applicant: Palo Alto Networks, Inc., Santa Clara, CA (US)

(72) Inventors: Shehroze Farooqi, Santa Clara, CA (US); Mohamed Yoosuf Mohamed Nabeel, San Jose, CA (US); William Russell Melicher, Sunnyvale, CA (US); Oleksii Starov, Sunnyvale, CA (US)

(21) Appl. No.: 18/774,568

(22) Filed: Jul. 16, 2024

(51) Int. Cl. H04L 9/40; G06F 21/56

(52) U.S. Cl. CPC H04L 63/1483; G06F 21/565

(57) ABSTRACT

A plurality of webpages is crawled for a corresponding open directory. It is determined that a source code archive included in a first open directory associated with a first webpage of the plurality of webpages is a phishing kit source code archive using a machine learning model. One or more actions are performed in response to determining that the source code archive included in the first open directory associated with the first webpage of the plurality of webpages is the phishing kit source code archive.

### BACKGROUND OF THE INVENTION

Off-the-shelf phishing kits have lowered the barrier for threat actors to launch phishing attacks. Threat actors no longer need to be coders. A phishing kit is typically distributed as an archive file. A threat actor may launch a phishing attack by simply uploading and decompressing a phishing kit source archive on a webserver to make the phishing landing page ready.

### BRIEF DESCRIPTION OF THE DRAWINGS

Various embodiments of the invention are disclosed in the following detailed description and the accompanying drawings.

FIG. 1 illustrates an example of a phishing kit.

FIG. 2 illustrates an example of a copycat webpage.

FIG. 3 illustrates an example of a cloaking script.

FIG. 4 illustrates an example of an exfiltration credential script.

FIG. 5 is a block diagram illustrating a system to detect phishing kit source code archives in accordance with some embodiments.

FIG. 6 is a flow diagram illustrating a process to train a machine learning model to detect phishing kit source code archives in accordance with some embodiments.

FIG. 7 is a flow diagram illustrating a process to detect phishing kits in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

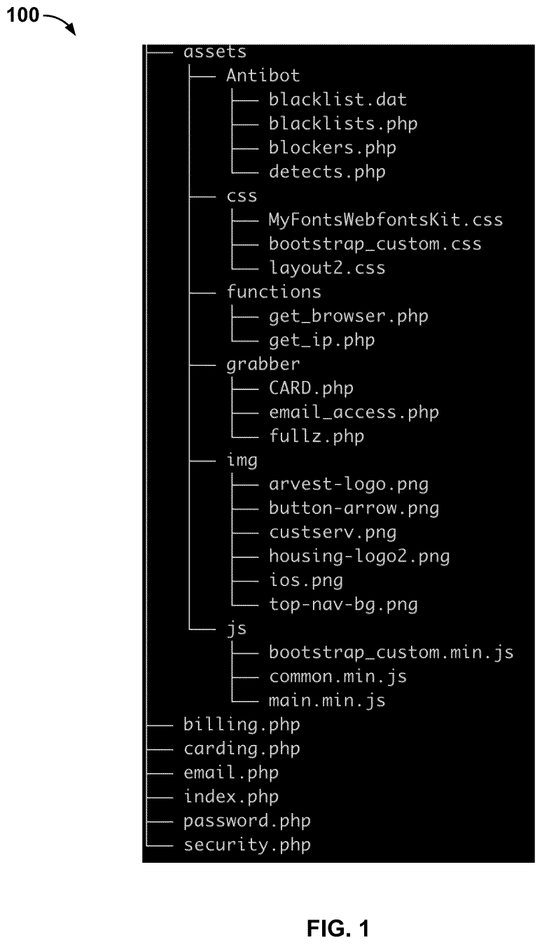

A typical phishing kit contains a collection of scripts (e.g., PHP, JavaScript, etc.), resources (e.g., images, fonts), and may also include admin panels or configuration files to set up phishing web pages. These may be bundled together in a phishing kit source code archive. An example of a phishing kit 100 is illustrated in FIG. 1. Off-the-shelf phishing kits have garnered attention because they implement complex features, which are built inside of them. These features include multi-factor authentication, evasive cloaking techniques, and credential exfiltration mechanisms. A threat actor could reuse these features with slight modifications rather than building them from scratch.

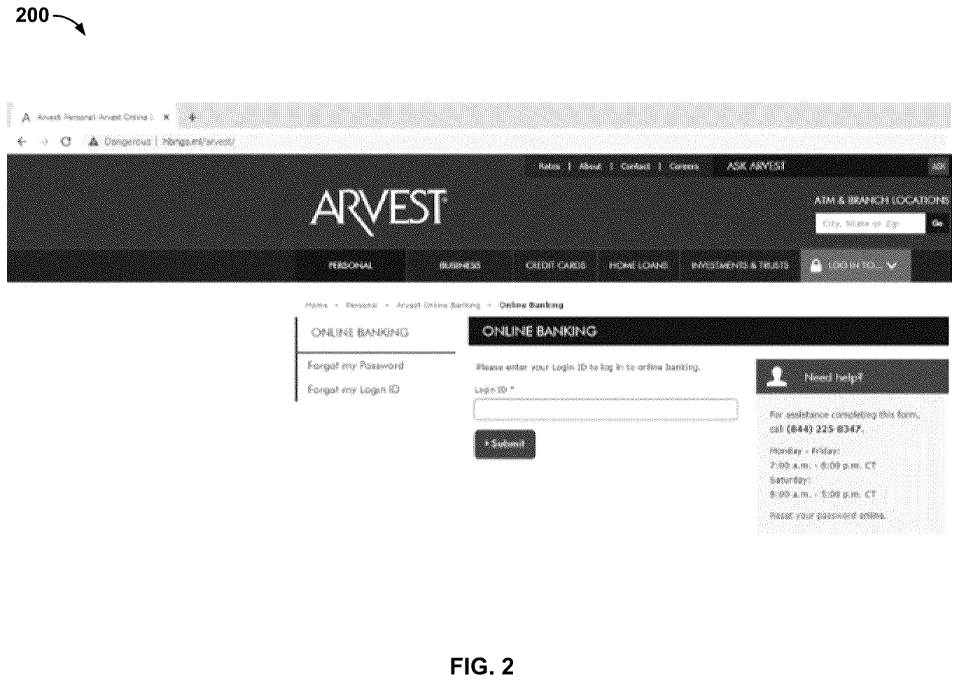

A phishing kit source code archive may include code to mimic the appearance of a legitimate webpage, such as a login page of a website. An example of a copycat webpage 200 is illustrated in FIG. 2.

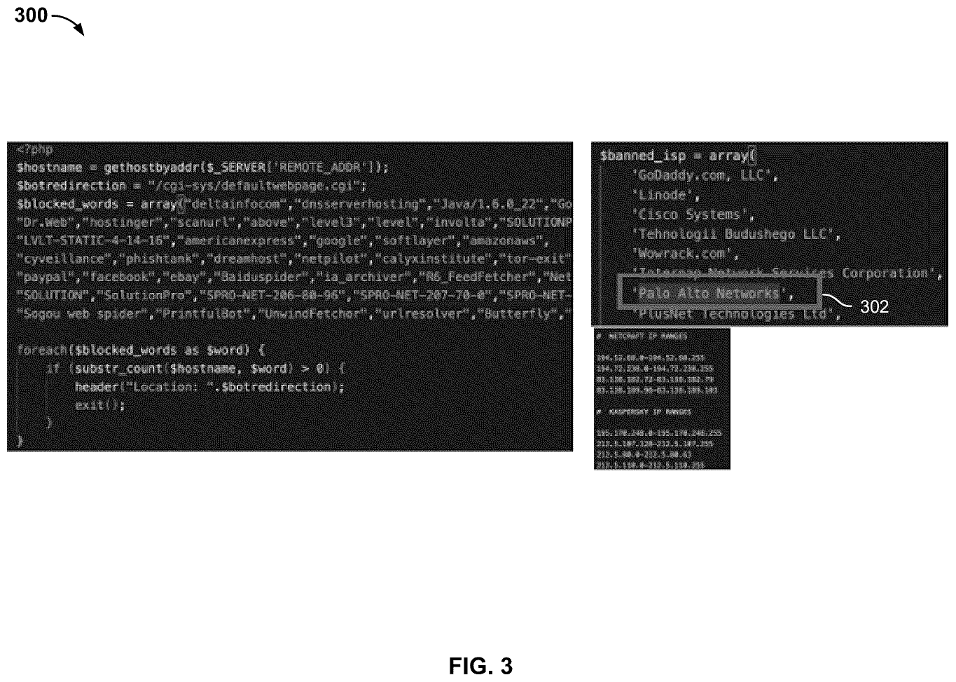

Security companies crawl the internet to discover phishing webpages. The phishing kit source code archive may include scripts to prevent security crawlers from discovering a phishing webpage. An example of a script 300 to prevent security crawlers from discovering a phishing webpage is illustrated in FIG. 3. The script 300 includes a list of names, such as name 302, that are prevented from accessing and launching the phishing webpage.

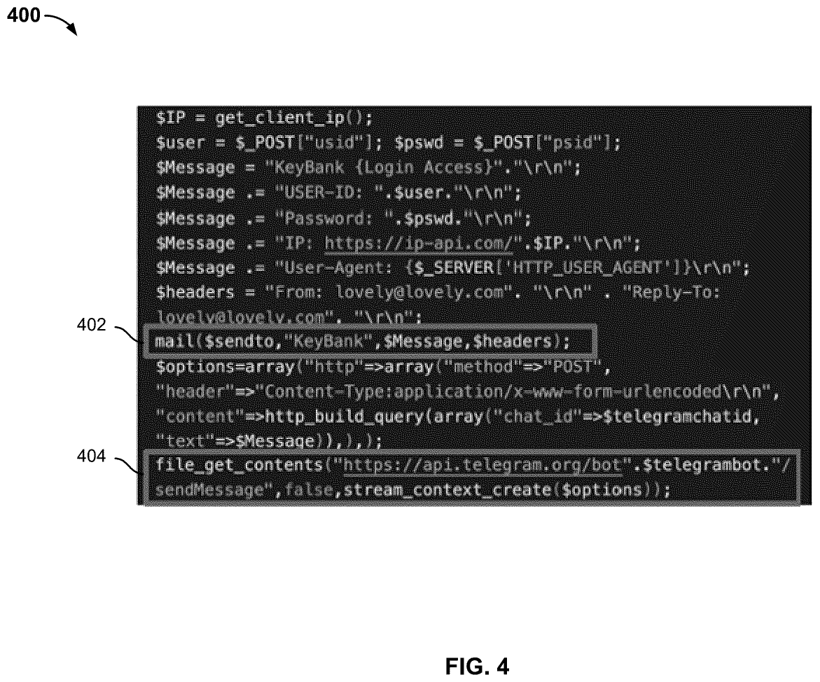

After a user enters their login information, the phishing kit source code archive includes code to exfiltrate the user's login information to a location from which the threat actor can access the user's login information. For example, the user's login information may be sent to a particular email account, stored in a plain text file, a message board, etc. An example of a script 400 to exfiltrate the user's login information is illustrated in FIG. 4. The script 400 includes a first location 402 and a second location 404.

Current systems may determine if a source code archive is a phishing kit source code archive by generating a signature for the source code archive. The generated signature is compared to a plurality of signatures associated with known phishing kit source code archives. However, there is an inherent limitation in this approach because if there is not a match, then it is assumed that the source code archive is benign. Slight modifications to a source code archive may cause the source code archive to go undetected.

A technique to detect phishing kit source code archives is disclosed herein. The disclosed technique enables a phishing webpage to be detected without visiting the phishing webpage. The disclose technique also bypasses the cloaking abilities associated with a phishing webpage, allowing the phishing webpage to be detected.

The technique includes developing a ground truth by training one or more machine learning models to detect phishing kit source code archives. Training the one or more machine learning models includes obtaining a plurality of known benign source code, i.e., source code that is associated with a legitimate website. In some embodiments, known benign source code is obtained from a public code repository (e.g., GitHub®). The benign source code may be in a particular coding language (e.g., PHP) that matches the type of coding language used in a phishing kit source code archive. In some embodiments, a plurality of machine learning models are trained, each of the plurality of machine learning models trained to detect a phishing kit source code archive in a particular coding language. In some embodiments, a single machine learning model is trained to detect a phishing kit source code archive in a plurality of different coding languages.

Particular search terms (e.g., login, shopping, mailer, Telegram) may be used to refine a search on the public code repository to identify benign source code that may be similar to phishing source code. The identified benign source code is utilized to train the one or more machine learning models to identify phishing versions of the benign source code.

Phishing kit source code is obtained to train the one or more machine learning models. The phishing kit source code may be obtained from one or more previous detections of phishing attacks. For example, previous phishing attacks have a particular signature that is known. The source codes associated with those previous phishing attacks are obtained. In some embodiments, phishing kit source codes are obtained from publicly available sources.

A plurality of features is extracted from the source code associated with previous phishing attacks and benign repositories. The plurality of features may include presence of credential exfiltration (e.g., Telegram/mail API), source code associated with cloaking artifacts (e.g., redirections, AS names, .htaccess), geolocation APIs (e.g., geoplugin.net, ip-tracker.org), obfuscation APIs (e.g., “document.write(unescaped”, “eval(base64_decode”), variables (e.g., $_POST, $_FILES, $SESSION and $_COOKIE), and/or suspicious filenames/folders of commonly targeted brands (e.g., PayPal, Chase) or specific purposes (e.g., htaccess, robotstxt). These features are either calculated as Boolean or numeric values or both. An example of a Boolean feature is whether or not a telegram API is present. An example of a numeric feature is the number of times a telegram API was used.

The obtained benign source code, the obtained phishing kit source code, and the extracted features are utilized to train the one or more machine learning models. The one or more machine learning models may be trained using supervised learning, unsupervised learning, semi-supervised, reinforcement learning, etc. In some embodiments, one of the one or more machine learning models is a random forest model.

The technique further includes crawling a plurality of web pages (e.g., millions, hundreds of millions) to determine if they include a corresponding open directory. Open directories are freely accessible links to files hosted on a webserver that's connected to the Internet, and not subject to any authentication methods or external access rules. A threat actor may leave behind one or more artifacts in an open directory, such as a phishing kit source code archive.

In response to detecting a web page that includes an open directory (also referred to as an “open directory web page), all of the files associated with the open directory are identified and provided to a phishing kit detection module. The phishing kit detection module includes a pre-filter that removes unnecessary files, such as executables and pdfs, from the files to generate a set of archive files for analysis. Each archive file is provided to a feature extractor configured to extract one or more features. The extracted feature(s), if any, are provided to the trained machine learning model to determine whether the source code archive is benign or a phishing kit source code archive. In some embodiments, the trained machine learning model determines that the extracted features are associated with benign source code. In some embodiments, the trained machine learning model determines that the extracted features are associated with phishing kit source code.

In response to a determination that the extracted features are associated with phishing kit source code, the phishing kit detection module performs one or more actions. The phishing kit detection module may store the set of archive files in a phishing kit database, store the indicators of compromise (IoCs) extracted from the set of archive files in the phishing kit database (which can be used to detect other live phishing attacks), add to a blacklist the webpage associated with the open directory from which the set of archive files are stored, provide to a detection module that determines the paths where the phishing kit is potentially launched, which is also added to the blacklist.

As a result, the disclosed technique may detect a phishing attack before it is launched. Traditional approaches to detect phishing attacks are reactive. In contrast, the disclosed technique is proactive by periodically scanning open directories to detect a phishing attack that may not have been launched yet.

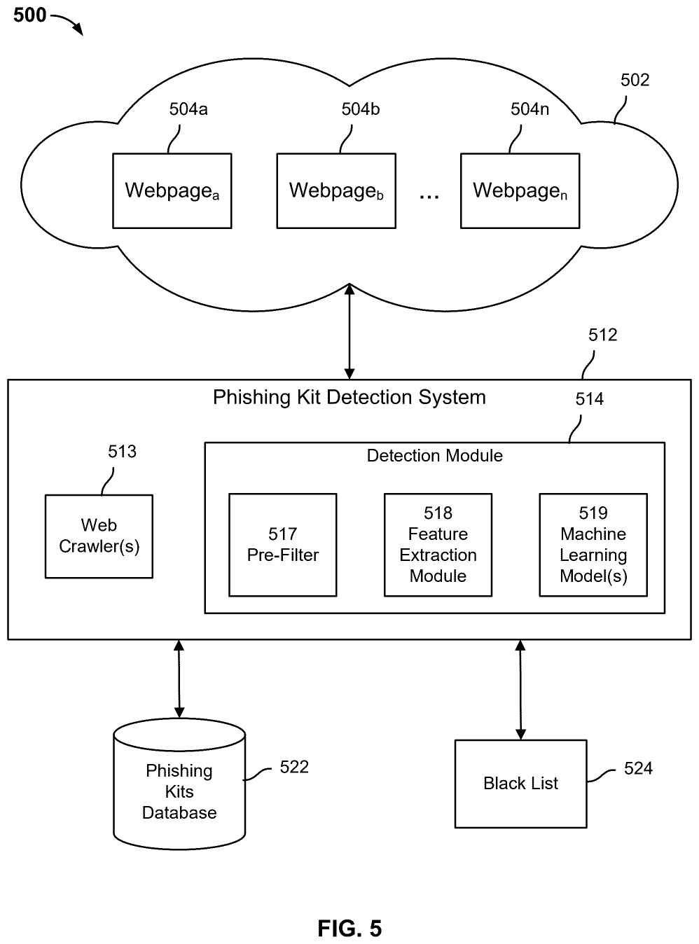

FIG. 5 is a block diagram illustrating a system to detect phishing kit source code archives in accordance with some embodiments. In the example shown, system 500 includes a phishing kit detection system 512 having one or more web crawlers 513 configured to crawl the internet 502 for webpages 504a, 504b, . . . , 504b. Phishing kit detection system 512 may be implemented on a server, a computer, a desktop, a laptop, a smartphone, a tablet, or any other electronic device with access to internet 502. Although FIG. 5 depicts three webpages, the one or more web crawlers 513 may crawl internet 502 for 1:n webpages. The one or more web crawlers 513 are configured to detect if a webpage includes an open directory.

In response to detecting a webpage that includes an open directory, the one or more web crawlers 513 is configured to identify all of the files associated with the open directory and provide the identified file(s) to phishing kit detection module 512. Phishing kit detection module 512 includes pre-filter 517. Pre-filter 517 is configured to removes unnecessary files, such as executables and pdfs, from the files to generate a set of archive files for analysis. Pre-filter 517 provides each archive file to feature extraction module 518 to extract one or more features. The plurality of features may include presence of credential exfiltration (e.g., Telegram/mail API), source code associated with cloaking artifacts (e.g., redirections, AS names, .htaccess), geolocation APIs (e.g., geoplugin.net, ip-tracker.org), obfuscation APIs (e.g., “document.write(unescaped”, “eval(base64_decode”), variables (e.g., $_POST, $_FILES, $SESSION and $_COOKIE), and/or suspicious filenames/folders of commonly targeted brands (e.g., PayPal, Chase) or specific purposes (e.g., htaccess, robotstxt).

Feature extraction module 518 is configured to input the one or more extracted features, if any, to the one or more machine learning models 519. Based on the one or more extracted features, the one or more machine learning models 519 are configured to output a value that indicates whether the one or more extracted features is associated with a benign source code archive or a phishing kit source code archive.

In response to a value that indicates that the one or more extracted features is associated with a phishing kit source code archive, phishing kit detection module 514 is configured to perform one or more actions. Phishing kit detection module 514 may store the set of archive files in phishing kits database 522, store the IoCs extracted from the set of archive files in phishing kits database 522, add to blacklist 524 the webpage associated with the open directory from which the set of archive files are stored, provide to a detection module that determines the paths where the phishing kit is potentially launched, and add this path to a blacklist.

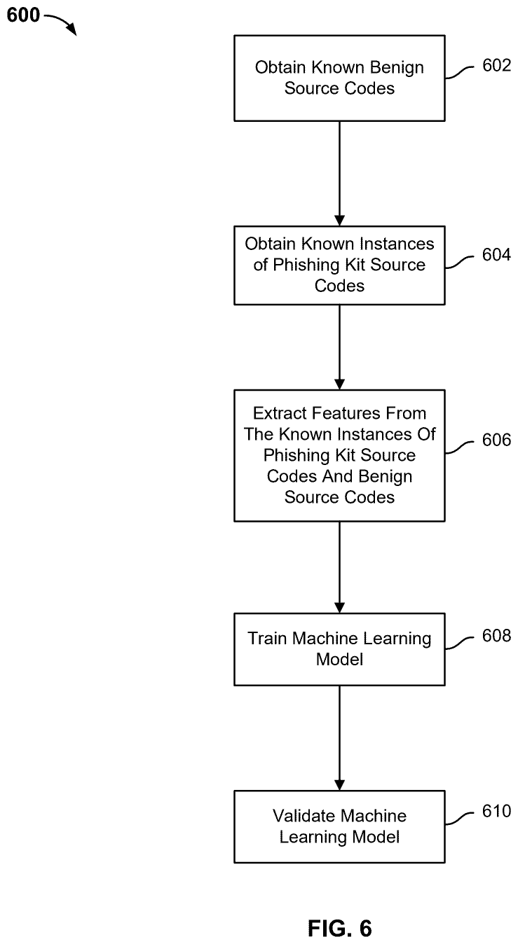

FIG. 6 is a flow diagram illustrating a process to train a machine learning model to detect phishing kit source code archives in accordance with some embodiments. In the example shown, process 600 may be implemented by a phishing kit detection system, such as phishing kit detection system 512.

At 602, known benign source codes are obtained. In some embodiments, known benign source code is obtained from a public code repository (e.g., GitHub®). The benign source code may be in a particular coding language (e.g., PHP) that matches the type of coding language used in a phishing kit source code archive. Particular search terms (e.g., login, shopping, mailer, Telegram) may be used to refine a search on the public code repository to identify benign source code that may be similar to phishing source code.

At 604, known instances of phishing kit source codes are obtained. The phishing kit source code may be obtained from one or more previous detections of phishing attacks. For example, previous phishing attacks have a particular signature that is known. The source code associated with those previous phishing attacks is obtained. In some embodiments, phishing kit source code is obtained from publicly available sources.

At 606, features are extracted from the known instances of phishing kit source codes and benign source codes. The plurality of features may include presence of credential exfiltration (e.g., Telegram/mail API), source code associated with cloaking artifacts (e.g., redirections, AS names, .htaccess), geolocation APIs (e.g., geoplugin.net, ip-tracker.org), obfuscation APIs (e.g., “document.write(unescaped”, “eval(base64_decode”), variables (e.g., $_POST, $_FILES, $SESSION and $_COOKIE), and/or suspicious filenames/folders of commonly targeted brands (e.g., PayPal, Chase) or specific purposes (e.g., htaccess, robotstxt). These features are either calculated as Boolean or numeric values or both. An example of a Boolean feature is whether or not a telegram API is present. An example of a numeric feature is the number of times a telegram API was used.

At 608, a machine learning model is trained based on the known benign source codes, the known instances of phishing kit source codes, and the extracted features. The one or more machine learning models may be trained using supervised learning, unsupervised learning, semi-supervised, reinforcement learning, etc. In some embodiments, one of the one or more machine learning models is a random forest model.

At 610, the machine learning model is validated. The machine learning model may be validated by utilizing a ten fold cross validation method. The machine learning model may also be validated by utilizing a different set of known phishing and benign archives to test the machine learning model.

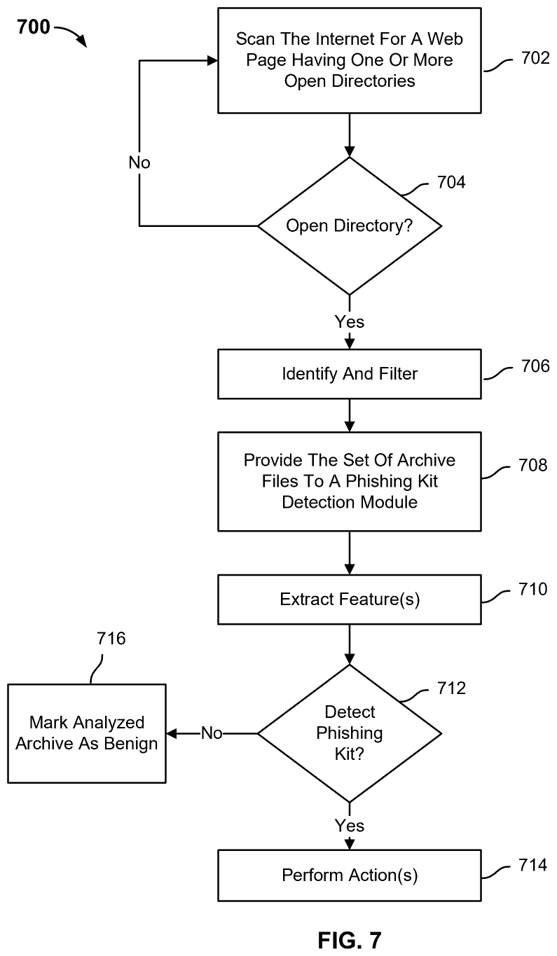

FIG. 7 is a flow diagram illustrating a process to detect phishing kits in accordance with some embodiments. In the example shown, process 600 may be implemented by a phishing kit detection system, such as phishing kit detection system 512.

At 702, the internet is scanned for one or more open directory web pages. Open directories are freely accessible links to files hosted on a webserver that's connected to the Internet, and not subject to any authentication methods or external access rules. A threat actor may leave behind one or more artifacts in an open directory, such as a phishing kit source code archive.

At 704, it is determined whether a web page includes an open directory. In response to a determination that the web page does not include an open directory, process 700 returns to 702. In response to a determination that the web page includes an open directory, process 700 proceeds to 706.

At 706, all of the files associated with the open directory are identified and unnecessary files are filtered to generate a set of archive files for analysis. The phishing kit detection module includes a pre-filter that removes unnecessary files, such as executables and pdfs, from the files.

At 708, the set of archive files are provided to a phishing kit detection module.

At 710, one or more features are extracted from the set of archive files. The plurality of features may include presence of credential exfiltration (e.g., Telegram/mail API), source code associated with cloaking artifacts (e.g., redirections, AS names, .htaccess), geolocation APIs (e.g., geoplugin.net, ip-tracker.org), obfuscation APIs (e.g., “document.write(unescaped”, “eval(base64_decode”), variables (e.g., $_POST, $_FILES, $SESSION and $_COOKIE), and/or suspicious filenames/folders of commonly targeted brands (e.g., PayPal, Chase) or specific purposes (e.g., htaccess, robotstxt). These features are either calculated as Boolean or numeric values or both. An example of a Boolean feature is whether or not a telegram API is present. An example of a numeric feature is the number of times a telegram API was used.

At 712, it is determined whether the set of archive files are associated with a phishing kit source code archive. The extracted feature(s) are provided to the trained machine learning model to determine whether the source code archive is benign or a phishing kit source code archive. In response to a determination that the extracted feature(s) are associated with a phishing kit source code archive, process 700 proceeds to 714. In response to a determination that the extracted feature(s) are associated with a benign kit source code, process 700 proceeds to 716.

At 714, one or more actions are performed. The phishing kit detection module may store the set of archive files in a phishing kit database, store the indicators of compromise (IoCs) extracted from the set of archive files in the phishing kit data base (which can be used to detect other live phishing attacks), add to a blacklist the webpage associated with the open directory from which the set of archive files are stored, provide to a detection module that determines the paths where the phishing kit is potentially launched, which is also added to the blacklist.

At 716, the analyzed archive is marked as benign.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
crawling a plurality of webpages for a corresponding open directory;
determining that a source code archive included in a first open directory associated with a first webpage of the plurality of webpages is a phishing kit source code archive using a machine learning model; and
performing one or more actions in response to determining that the source code archive included in the first open directory associated with the first webpage of the plurality of webpages is the phishing kit source code archive.

2. The method of claim 1, further comprising identifying all files included in the first open directory.

3. The method of claim 2, further comprising filtering the files to generate a set of archive files.

4. The method of claim 3, wherein unnecessary files are removed from the files to generate the set of archive files.

5. The method of claim 3, further comprising extracting one or more features from the set of archive files.

6. The method of claim 5, wherein the extracted features include presence of credential exfiltration, cloaking artifacts, geolocation APIs, obfuscation APIs, variables, and/or suspicious filenames/folders.

7. The method of claim 1, wherein the machine learning model is trained using supervised learning, unsupervised learning, semi-supervised, or reinforcement learning.

8. The method of claim 1, wherein the machine learning model is a random forest model.

9. The method of claim 1, wherein determining that the source code archive included in the first open directory associated with the first webpage is the phishing kit source code archive using the machine learning model includes providing one or more extracted features to the machine learning model.

10. The method of claim 1, wherein the one or more actions include storing the set of archive files in a phishing kit database.

11. The method of claim 1, wherein the one or more actions include storing indicators of compromise extracted from the set of archive files in a phishing kit database.

12. The method of claim 1, wherein the one or more actions include adding to a blacklist the first webpage associated with the first open directory.

13. The method of claim 1, wherein the one or more actions include determining paths from which the phishing kit source code archive is potentially launched.

14. A system, comprising:
a communication interface configured to crawl a plurality of webpages for a corresponding open directory; and
a processor coupled to the communication interface and configured to:
determine that a source code archive included in a first open directory associated with a first webpage of the plurality of webpages is a phishing kit source code archive using a machine learning model; and
perform one or more actions in response to determining that the source code archive included in the first open directory associated with the first webpage of the plurality of webpages is the phishing kit source code archive.

15. The system of claim 14, wherein the processor is configured to identify all files included in the first open directory.

16. The system of claim 15, wherein the processor is configured to filter the files to generate a set of the archive files.

17. The system of claim 16, wherein the processor is configured to extract one or more features from the set of archive files.

18. The system of claim 17, wherein the machine learning model is configured to determine that the source code archive included in the first open directory associated with the first webpage is the phishing kit source code archive based on the one or more extracted features.

19. The system of claim 14, wherein the one or more actions include storing the set of archive files in a phishing kit database.

20. A computer program product embodied in a non-transitory computer readable medium and comprising computer instructions for:
crawling a plurality of webpages for a corresponding open directory;
determining that a source code archive included in a first open directory associated with a first webpage of the plurality of webpages is a phishing kit source code archive using a machine learning model; and
performing one or more actions in response to determining that the source code archive included in the first open directory associated with the first webpage of the plurality of webpages is the phishing kit source code archive.
